(19) United States
(12) Patent Application Publication
(10) Pub. No.: US 2015/0319698 A1
(43) Pub. Date: Nov. 5, 2015

(54) POWER CONTROL DEVICE AND POWER CONTROL METHOD

(71) Applicant: FUJITSU LIMITED, Kawasaki-shi (JP)

(72) Inventors: Naoto Ohnishi, Yokohama (JP); Takuya Ishikawa, Yokohama (JP); Kenichirou Shimogawa, Numazu (JP)

(73) Assignee: FUJITSU LIMITED, Kawasaki-shi (JP)

(21) Appl. No.: 14/678,447

(22) Filed: Apr. 3, 2015

(30) Foreign Application Priority Data
May 2, 2014 (JP) 2014-095462

(51) Int. Cl. H04W 52/02; H04W 52/24

(52) U.S. Cl. CPC H04W 52/0251; H04W 52/246

(57) ABSTRACT

A power control device includes a processor. The processor is configured to acquire operating information indicating an operating status of each of first information processing devices connected to first communication equipment as lower level devices than the first communication equipment. The processor is configured to acquire connection information indicating a connection path of the first communication equipment and a connection status of the first communication equipment. The processor is configured to perform, based on the operating information and the connection information, control of power provided to the first communication equipment depending on the operating status of each of the first information processing devices.

### CROSS-REFERENCE TO RELATED APPLICATION

This application is based upon and claims the benefit of priority of the prior Japanese Patent Application No. 2014-095462, filed on May 2, 2014, the entire contents of which are incorporated herein by reference.

### FIELD

The embodiments discussed herein are related to a power control device and a power control method.

### BACKGROUND

An information processing system is known in which each of a plurality of computers, such as servers, runs in a network environment. In general, computers that are not in operation are turned off (shutdown) to reduce power consumption in the network environment. In some cases, each of the plurality of computers uses a dedicated storage device. When computers that are not in operation are turned off, the dedicated storage device of each computer that is not in operation is turned off, so that power consumption of the information processing system is reduced.

As an exemplary technique for reducing power consumption of an information processing system by turning off a storage device, a technique is known in which the power consumption of the information processing system is reduced by managing power provided to a storage device shared by a plurality of computers. With this technique, in a virtual environment, the power consumption of an information processing system is reduced by managing power provided to a storage device shared by a plurality of computers running virtually.

A related technique is disclosed in, for example, Japanese Laid-open Patent Publication No. 2008-102667.

In the case where a plurality of computers are running in a network environment, each of the plurality of computers is generally connected to network equipment and exchanges information with other computers via the network equipment. Consequently, power consumption of an information processing system is insufficiently reduced merely by turning off a computer that is not in operation and turning off a storage device used by that computer.

### SUMMARY

According to an aspect of the present invention, provided is a power control device including a processor. The processor is configured to acquire operating information indicating an operating status of each of first information processing devices connected to first communication equipment as lower level devices than the first communication equipment. The processor is configured to acquire connection information indicating a connection path of the first communication equipment and a connection status of the first communication equipment. The processor is configured to perform, based on the operating information and the connection information, control of power provided to the first communication equipment depending on the operating status of each of the first information processing devices.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a power control system according to a first embodiment;

FIG. 2 is a diagram illustrating an example of a network environment;

FIG. 3 is a diagram illustrating an example of equipment held in a rack;

FIG. 4 depicts an example of network equipment list information;

FIG. 5 depicts an example of network equipment detailed information;

FIG. 6 depicts an example of physical server list information;

FIG. 7 is a diagram illustrating an example in which equipment is classified into some ranges within a network environment;

FIG. 8 is a diagram illustrating an example of a power control device implemented by a computer;

FIG. 9 is a flowchart illustrating an example of a flow of a status acquisition process;

FIG. 10A and FIG. 10B are flowcharts illustrating an example of a flow of a configuration management process;

FIG. 11 is a flowchart illustrating an example of a flow of a power control planning process;

FIG. 12A and FIG. 12B are flowcharts illustrating an example of a flow of a power check process;

FIG. 13 is a diagram illustrating a first range in which physical servers are connected to plural pieces of network equipment;

FIG. 14 depicts an example of physical server list information;

FIG. 15 depicts an example of network equipment detailed information;

FIG. 16 is a diagram illustrating an example of a relationship in which a switch is connected to a plurality of higher-level switches;

FIG. 17 is a flowchart illustrating an example of a flow of a rearrangement/initiation process;

FIG. 18 is a diagram illustrating an example of statuses of physical servers before migration of virtual machines;

FIG. 19 is a diagram illustrating an example of statuses of physical servers after migration of virtual machines;

FIG. 20 is a flowchart illustrating an example of a flow of a migration destination determination process;

FIG. 21 is a diagram illustrating statuses of pieces of equipment in the network environment;

FIG. 22 is a flowchart illustrating an example of a flow of an initiation determination process;

FIG. 23 is a flowchart illustrating an example of a flow of a power control process;

FIG. 24 is a diagram illustrating an example of a power control system according to a second embodiment; and

FIG. 25 is a diagram illustrating a power control device implemented by a computer.

### DESCRIPTION OF EMBODIMENTS

Hereinafter, a first embodiment will be described in detail with reference to the accompanying drawings. The first embodiment is directed to reducing power consumption of the entire network by performing power control for network equipment in accordance with an operating status of a server.

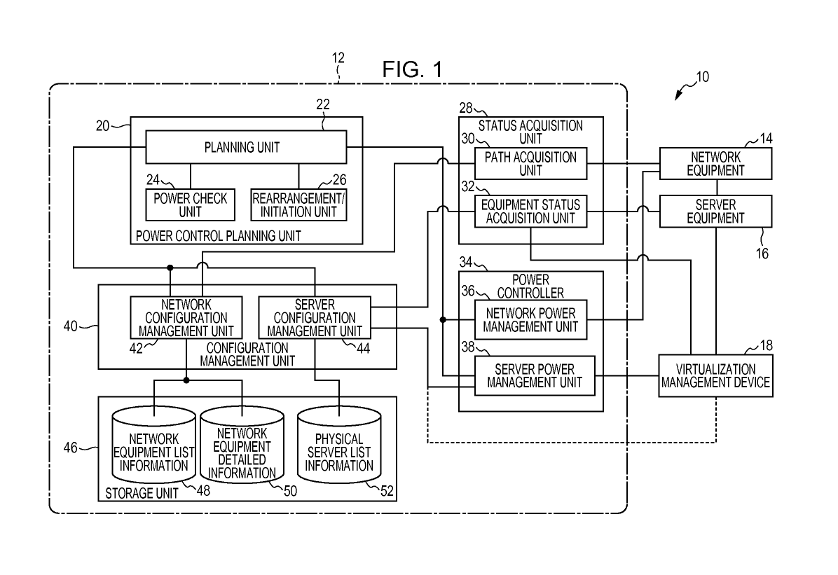

FIG. 1 illustrates an example of a power control system 10 according to the present embodiment. The power control system 10 includes a power control device 12, network equipment 14, server equipment 16, and a virtualization management device 18.

The power control system 10 manages an operating status of the server equipment 16 serving as an information processing device, a connection path of the network equipment 14 used by the server equipment 16 and serving as communication equipment to be controlled, and a connection status of the network equipment 14 to perform power control for the network equipment 14. The server equipment 16 includes physical servers and virtual machines. The virtual machine is a virtual information processing device built by running virtual machine (VM) software on the physical server. The server equipment 16 is connected to the network equipment 14. The server equipment 16 is also connected to the virtualization management device 18. The virtualization management device 18 is an information processing device that manages an operating status of each of a plurality of physical servers included in the server equipment 16 and each of a plurality of virtual machines running on the physical servers to control operations of the physical servers and the virtual machines. The virtualization management device 18 also executes a process of migrating a virtual machine running on a physical server to another physical server. The network equipment 14, the server equipment 16, and the virtualization management device 18 are connected to the power control device 12.

The power control device 12 includes a power control planning unit 20, a status acquisition unit 28, a power controller 34, a configuration management unit 40, and a storage unit 46.

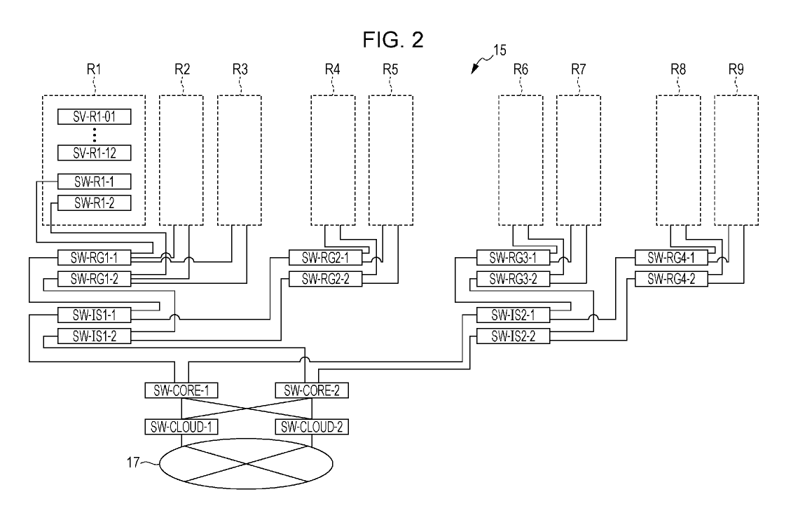

The status acquisition unit 28 includes a path acquisition unit 30 and an equipment status acquisition unit 32. The path acquisition unit 30 is connected to the network equipment 14 to acquire the connection path (path information) of the network equipment 14, the connection status of the network equipment 14, and the status of the network equipment 14 (the status of the network equipment 14 and the status of each port of the network equipment 14). The path acquisition unit 30 notifies the configuration management unit 40 when the acquired information differs (has been changed) from previously acquired information. The equipment status acquisition unit 32 is connected to the virtualization management device 18 and the server equipment 16 to acquire the status of the server equipment 16 in cooperation with the virtualization management device 18. The equipment status acquisition unit 32 also notifies the configuration management unit 40 when the server status has been changed, such as created, updated, deleted, or the like. Note that, information indicating a connection path of the network equipment 14 is obtained by performing a path search by using a path search tool at the time of building a network environment 15 (FIG. 2). Therefore, this information indicating a connection path of the network equipment 14 may be used. The status acquisition unit 28 may also include the path search tool.

The configuration management unit 40 includes a network configuration management unit 42 and a server configuration management unit 44. The configuration management unit 40 is connected to the power control planning unit 20, the status acquisition unit 28, the power controller 34, and the storage unit 46. Note that the configuration management unit 40 may be connected to the virtualization management device 18. The network configuration management unit 42 is connected to the power control planning unit 20 and the path acquisition unit 30 of the status acquisition unit 28. The network configuration management unit 42 acquires the status of the network equipment 14 to update management information related to the network equipment 14 when the status has been changed. The network configuration management unit 42 also notifies the power control planning unit 20 when the status of the network equipment 14 has been changed. The server configuration management unit 44 is connected to the power controller 34 and the equipment status acquisition unit 32 of the status acquisition unit 28. The server configuration management unit 44 may be connected to the virtualization management device 18 (indicated by a broken line in FIG. 1). The server configuration management unit 44 acquires the status of the server equipment 16 to update management information related to the server equipment 16 when the status of the server equipment 16 has been changed. The server configuration management unit 44 also notifies the power control planning unit 20 when the status of the server equipment 16 has been changed.

The power control planning unit 20 includes a planning unit 22, a power check unit 24, and a rearrangement/initiation unit 26. The planning unit 22 is connected to the power check unit 24, the rearrangement/initiation unit 26, the power controller 34, and the configuration management unit 40. The power control planning unit 20 plans, based on management information of various kinds of equipment managed by the network configuration management unit 42 and the server configuration management unit 44, power control for the network equipment 14 and migration (rearrangement) of a virtual machine to issue an instruction to the power controller 34. Note that, in the present embodiment, migration of a virtual machine on a physical server included in a specific range to a physical server included in another range is referred to as “rearrangement”, which will be described in detail later.

The power controller 34 includes a network power management unit 36 and a server power management unit 38. The network power management unit 36 is connected to the network equipment 14 and performs, in accordance with an instruction issued by the power control planning unit 20, power control of powering on or off for a piece of network equipment 14 specified in the instruction. The server power management unit 38 is connected to the virtualization management device 18 and executes, in accordance with an instruction issued by the power control planning unit 20, a process of issuing a request for migrating a virtual machine specified in the instruction. The instruction for migrating a virtual machine issued by the power control planning unit 20 may be received through the server configuration management unit 44 of the configuration management unit 40.

The storage unit 46 holds the status of the network equipment 14 and the status of the server equipment 16 as various kinds of management information. FIG. 1 illustrates an example where network equipment list information 48 and network equipment detailed information 50 are stored as management information related to the network equipment 14. FIG. 1 also illustrates an example where physical server list information 52 is stored as management information related to the server equipment 16.

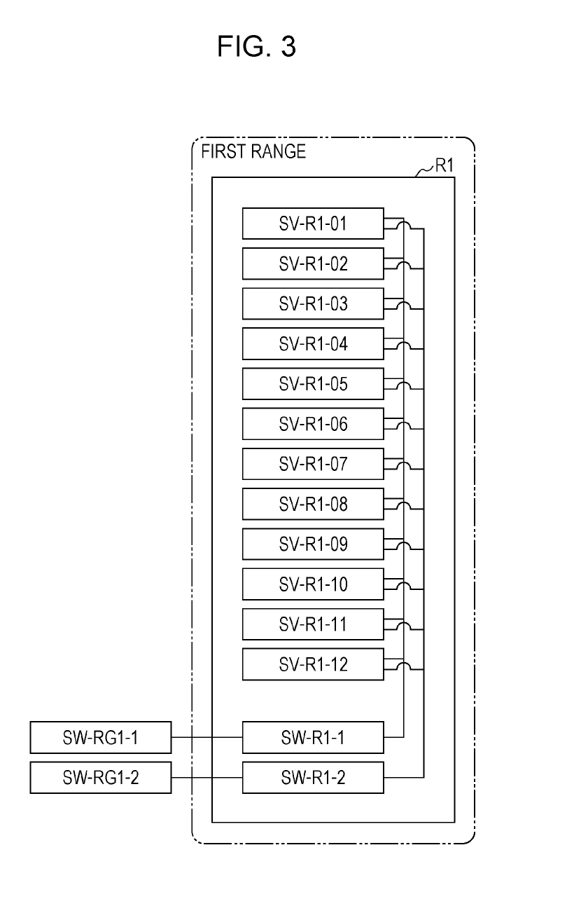

FIG. 2 illustrates an example of the network environment 15 including the network equipment 14 and the server equipment 16. FIG. 3 illustrates an example of the network equipment 14 and the server equipment 16 held in a rack. The network environment 15 illustrated in FIG. 2 includes nine racks R1 to R9. Twelve physical servers SV-R1-01 to SV-R1-12 are held in the rack R1, and switches SW-R1-1 and SW-R1-2 connected in a redundant manner to each of the twelve physical servers are also held in the rack R1 (refer also to FIG. 3). In FIG. 2, the name of a physical server SV is denoted by, for example, “SV-R1-01”, in which the identifier of a rack and the identifier indicating the number of each physical server are successively connected. Similarly, the name of a switch SW is denoted by, for example, “SW-R1-1”, in which the identifier of a rack and the identifier indicating the number of each switch are successively connected. Physical servers SV-Rm-01 to SV-Rm-12 are held in each of the racks R2 to R9, and switches SW-Rm-1 and SW-Rm-2 are also held in each of the racks R2 to R9 (m=2 to 9).

Note that, hereinafter, a physical server in the network environment 15 is simply referred to as “a physical server SV” when a description is given without making a distinction among the physical servers. A switch in the network environment 15 is simply referred to as “a switch SW” when a description is given without making a distinction among the switches.

The switch SW-R1-1 in the rack R1 is connected to a switch SW-RG1-1 at a higher level, and the switch SW-R1-2 is connected to a switch SW-RG1-2 at the higher level. Additionally, the switch SW-RG1-1 is connected to a switch SW-IS1-1 whose level is higher than the switch SW-RG1-1, and a switch SW-RG1-2 is connected to a switch SW-IS1-2 whose level is also higher than the switch SW-RG1-2.

The switch SW-IS1-1 is connected to a switch SW-CORE-1 connected to a switch SW-CLOUD-1 and a switch SW-CLOUD-2. The switch SW-CLOUD-1 and the switch SW-CLOUD-2 are connected to the network 17. The switch SW-IS1-2 is connected to a switch SW-CORE-2 connected to the switch SW-CLOUD-1 and the switch SW-CLOUD-2.

The switch SW-RG1-1 is also connected to a switch SW in the rack R2 and a switch SW in the rack R3. The switch SW-RG1-2 is also connected to a switch SW in the rack R2 and a switch SW in the rack R3.

The switch SW-IS1-1 is connected to a switch SW-RG2-1 connected to a switch SW in the rack R4 and a switch SW in the rack R5. The switch SW-IS1-2 is connected to a switch SW-RG2-2 connected to a switch SW in the rack R4 and a switch SW in the rack R5.

The switch SW-CORE-1 is connected through a switch SW-IS2-1 and a switch SW-RG3-1 to a switch SW in the rack R6 and a switch SW in the rack R7. The switch SW-CORE-1 is also connected through the switch SW-IS2-1 and a switch SW-RG4-1 to a switch SW in the rack R8 and a switch SW in the rack R9.

The switch SW-CORE-2 is connected through a switch SW-IS2-2 and a switch SW-RG3-2 to a switch SW in the rack R6 and a switch SW in the rack R7. The switch SW-CORE-2 is also connected through the switch SW-IS2-2 and a switch SW-RG4-2 to a switch SW in the rack R8 and a switch SW in the rack R9.

Consequently, in the network environment 15 illustrated in FIG. 2, each physical server SV serving as the server equipment 16 is connected through switches SW serving as the network equipment 14 to the network 17.

The network equipment 14 connected to a physical server SV may be powered off (power shutdown) or powered on (power on) by manual operations. However, in general, power provided to the network equipment 14 is not controlled, and the network equipment 14 is typically used in a state of powered on at all times. For example, when a piece of network equipment 14 is to be powered off, it is supposed that all the physical servers SV connected to the piece of network equipment 14 are in a state of powered off. Additionally, for other pieces of network equipment 14 arranged along a network path from the piece of network equipment 14 to be powered off to a physical server SV, it is supposed that physical servers SV connected to the other pieces of network equipment 14 are in a state of powered off. Moreover, when a physical server SV in a state of powered off is to be powered on, all pieces of network equipment 14 arranged along a network path connected to the physical server SV are supposed to be powered on.

In the present embodiment, power control is performed for the network equipment 14 arranged along a network path to which the server equipment 16 is connected. For example, when network equipment 14 arranged along a network path to which a physical server SV to be powered on is connected is in a state of powered off, a piece of network equipment 14 with which the physical server SV communicates is identified, and the identified piece of network equipment 14 is powered on. When a physical server SV is in a state of powered off, it is determined whether or not each piece of network equipment 14 arranged along a network path to which the physical server SV is connected is used for another physical server SV, and pieces of network equipment 14 determined as being not used are powered off.

In the present embodiment, in order to perform power control for the network equipment 14 arranged along a network path, the network equipment 14 and the like included in the network environment 15 are classified into the following three types of ranges. A first range, which is a minimum unit range, includes one piece of network equipment 14 and physical servers SV connected, as subordinates, to the one piece of network equipment 14. Note that a physical configuration range including the network equipment 14 and physical servers SV contained in one rack or the like may be regarded as the first range. In the case where redundancy is provided for a network path, the redundant network paths may be included in the first range. A second range includes one or more first ranges and the network equipment 14 at a higher level, which is connected to the network equipment 14 included in the one or more first ranges. A third range includes one or more second ranges and the network equipment 14 at a yet higher level, which is connected to the network equipment 14 included in the one or more second ranges. In the present embodiment, power control for the network equipment 14 is performed for each of the first to third ranges. Note that the numbers of stages of the second range and the third range increase and decrease in accordance with the equipment configuration including the server equipment 16 and the network equipment 14 in the network environment 15.

The network equipment 14 included in each of the first to third ranges may be a control target system of power control for the network equipment 14 within the network environment 15. The control target system may include physical servers SV connected to the network equipment 14.

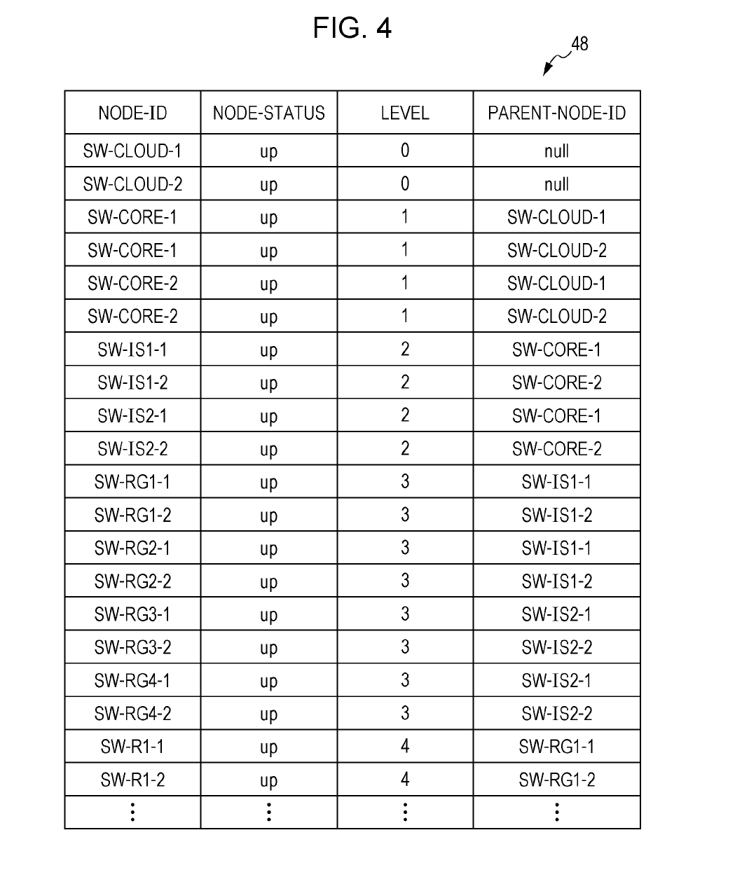

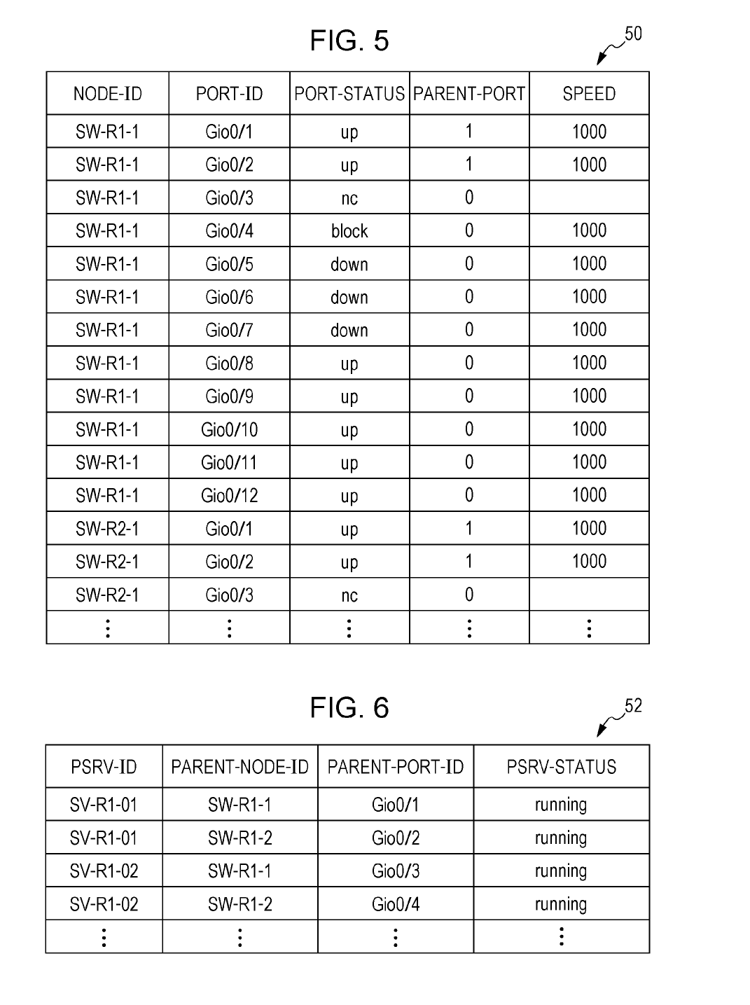

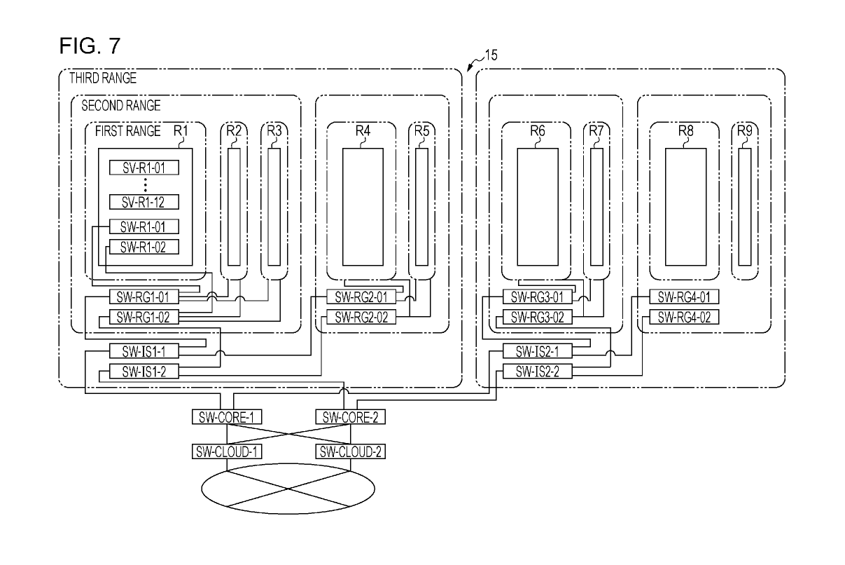

In the present embodiment, to perform power control for the network equipment 14 in each of the first to third ranges, the network equipment list information 48 (FIG. 4), the network equipment detailed information 50 (FIG. 5), and the physical server list information 52 (FIG. 6) are stored as management information in the storage unit 46. Each piece of network equipment 14 is sometimes described as a node in the network environment 15 hereinafter.

FIG. 4 depicts an example of the network equipment list information 48. The network equipment list information 48 is management information of a list of the network equipment 14 in the network environment 15. In the example of FIG. 4, the network equipment list information 48 includes information representing individual ones of a node identifier (ID) (denoted by NODE-ID), a node status (denoted by NODE-STATUS), a level (denoted by LEVEL), and a higher-level network equipment ID (denoted by PARENT-NODE-ID). In the example of FIG. 4, the network equipment list information 48 is presented as a table in which information representing NODE-ID, NODE-STATUS, LEVEL, and PARENT-NODE-ID are associated with one another for each piece of network equipment 14.

In the example of FIG. 4, NODE-ID is identification information unique to a piece of network equipment 14, and a name of the piece of network equipment 14 is stored as NODE-ID. NODE-STATUS is information indicating a status of the piece of network equipment 14. As NODE-STATUS, a value of “up” is stored in the case where the piece of network equipment 14 is running, and a value of “down” is stored in the case where the piece of network equipment 14 is stopped. LEVEL is information indicating the number of connection stages from a gateway in the network environment 15. The gateway is a piece of network equipment 14 serving as a root for connection from the network environment 15 to another network environment or the like. LEVEL of the piece of network equipment 14 serving as a root is set to “0”. PARENT-NODE-ID is identification information unique to a piece of higher-level network equipment 14 connected to the piece of network equipment 14 concerned, and, in FIG. 4, a name of the piece of higher-level network equipment 14 is stored as PARENT-NODE-ID.

FIG. 5 depicts an example of the network equipment detailed information 50. The network equipment detailed information 50 is management information storing statuses of connection ports of each piece of network equipment 14. In the example of FIG. 5, the network equipment detailed information 50 includes information indicating individual ones of a node ID (denoted by NODE-ID), a port ID (denoted by PORT-ID), a port status (denoted by PORT-STATUS), a connection port (denoted by PARENT-PORT), and a communication speed (denoted by SPEED). In the example of FIG. 5, the network equipment detailed information 50 is presented as a table in which information indicating NODE-ID, PORT-ID, PORT-STATUS, PARENT-PORT, and SPEED are associated with one another for each piece of network equipment 14.

In the example of FIG. 5, NODE-ID is identification information unique to a piece of network equipment 14, and a name of the piece of network equipment 14 is stored as NODE-ID. PORT-ID is identification information of each connection port of the piece of network equipment 14, and a predetermined ID of the port is stored as PORT-ID. PORT-STATUS is information indicating a status of each port of the piece of network equipment 14. A value of “up” is stored as PORT-STATUS when the port is operating, a value of “down” is stored when the port is stopped, a value of “nc” is stored when the port is not connected, and a value of “block” is stored when the port is connected and is not being used. PARENT-PORT is information indicating whether a piece of network equipment 14 connected to the port is at a higher level or at a lower level. When the piece of network equipment 14 connected to the port is at a higher level, a value of “1” is stored as PARENT-PORT. When the piece of network equipment 14 connected to the port is at a lower level, a value of “0” is stored as PARENT-PORT. Information indicating a speed of communication via the connection port is stored as SPEED.

FIG. 6 depicts an example of the physical server list information 52. The physical server list information 52 is management information representing a list of physical servers SV connected to the network equipment 14. In the example of FIG. 6, the physical server list information 52 includes information indicating each of an ID (denoted by PSRV-ID) of a physical server SV, an ID (denoted by PARENT-NODE-ID) of a piece of network equipment serving as a connection destination, a port ID (denoted by PARENT-PORT-ID) of the piece of network equipment serving as the connection destination, and a status (denoted by PSRV-STATUS) of the physical server SV. In the example of FIG. 6, the physical server list information 52 is presented as a table in which information indicating PSRV-ID, PARENT-NODE-ID, PARENT-PORT-ID, and PSRV-STATUS are associated with one another for each physical server SV.

In the example of FIG. 6, PSRV-ID is identification information unique to a physical server SV, and a name of the physical server SV is stored as PSRV-ID. PARENT-NODE-ID is identification information of a piece of network equipment 14 serving as a connection destination of the physical server SV, and a name of the piece of network equipment 14 is stored as PARENT-NODE-ID. PARENT-PORT-ID is information indicating a port ID of the piece of network equipment serving as the connection destination. PSRV-STATUS is information indicating a status of the physical server SV. A value of “running” is stored as PSRV-STATUS when the physical server SV is running, a value of “off” is stored when the physical server SV is in a state of powered off, and a value of “on” is stored when the physical server SV is in a state of powered on.

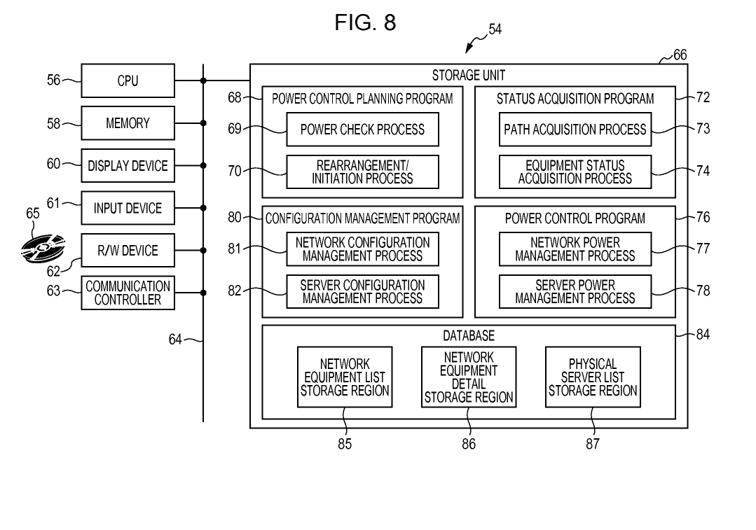

FIG. 7 illustrates a situation in which, the network equipment 14 and the server equipment 16 are classified into the first to third ranges in the network environment 15.

In the present embodiment, it is assumed that management information created at the time of building the network environment 15 under the condition that the network equipment 14 and the server equipment 16 are running is stored in the storage unit 46. That is, at the time of building the network environment 15, the operating status of the network environment 15 is acquired under the condition that the network equipment 14 and the server equipment 16 are running. The operating status of the network environment 15 includes the connection path of the network equipment 14, the connection status of the network equipment 14, and the status of the network equipment 14 (the status of the network equipment 14 and the status of each port of the network equipment 14). The operating status of the network environment 15 also includes the status of the server equipment 16 (the status of the server equipment 16 and the status of each port of the server equipment 16). Based on the acquired operating status of the network environment 15, management information is created and is stored in the storage unit 46 of the power control device 12. For example, at the time of building the network environment 15, information indicating the status, connection path, and connection status of each of the network equipment 14 and the server equipment 16 may be obtained by performing a path search by using a path search tool. The path search tool is, for example, assumed to include a function of searching for a connection path that starts from the network 17, passes through the network equipment 14, and reaches the server equipment 16. Based on information presented in a search result of the path search tool, the network equipment list information 48, the network equipment detailed information 50, and the physical server list information 52 are created as management information and are stored in the storage unit 46. The status acquisition unit 28 may include the path search tool.

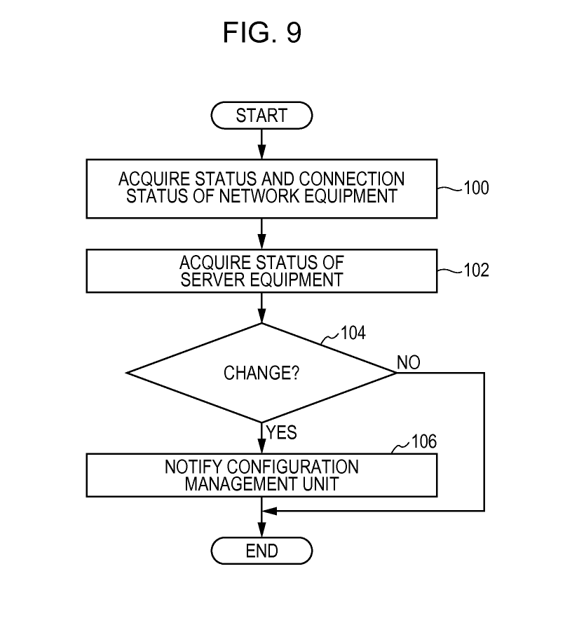

The power control device 12 included in the power control system 10 may be, for example, implemented by a computer 54 illustrated in FIG. 8. The computer 54 includes a central processing unit (CPU) 56, a memory 58, and a nonvolatile storage unit 66. The CPU 56, the memory 58, and the storage unit 66 are connected to one another via a bus 64. The computer 54 also includes a display device 60 such as a display and an input device 61 such as a keyboard and a mouse. The display device 60 and the input device 61 are connected to the bus 64. The computer 54 further includes a device (R/W device) 62 for reading from and writing to a recording medium 65. The R/W device 62 is connected to the bus 64. In addition, the computer 54 includes a communication controller 63 including an interface for connection to each of the network equipment 14, the server equipment 16, and the virtualization management device 18. The storage unit 66 may be implemented by a hard disk drive (HDD), a flash memory, or the like.

A program for causing the computer 54 to function as the power control device 12, and information are stored in the storage unit 66. Specifically, a power control planning program 68, a status acquisition program 72, a power control program 76, and a configuration management program 80 are stored in the storage unit 66. A database 84 including a network equipment list storage region 85, a network equipment detail storage region 86, and a physical server list storage region 87 is also stored in the storage unit 66.

The CPU 56 reads the status acquisition program 72 from the storage unit 66 and loads the status acquisition program 72 in the memory 58, and sequentially executes processes described in the status acquisition program 72. As a result, the computer 54 operates as the status acquisition unit 28 illustrated in FIG. 1. The status acquisition program 72 includes descriptions of a path acquisition process 73 and an equipment status acquisition process 74. The CPU 56 operates as the path acquisition unit 30 illustrated in FIG. 1 by executing the path acquisition process 73. The CPU 56 also operates as the equipment status acquisition unit 32 illustrated in FIG. 1 by executing the equipment status acquisition process 74.

The CPU 56 reads the configuration management program 80 from the storage unit 66 and loads the configuration management program 80 in the memory 58, and sequentially executes processes described in the configuration management program 80. As a result, the computer 54 operates as the configuration management unit 40 illustrated in FIG. 1. The configuration management program 80 includes descriptions of a network configuration management process 81 and a server configuration management process 82. The CPU 56 operates as the network configuration management unit 42 illustrated in FIG. 1 by executing the network configuration management process 81. The CPU 56 also operates as the server configuration management unit 44 illustrated in FIG. 1 by executing the server configuration management process 82.

When the power control device 12 is implemented by the computer 54, the network equipment list storage region 85 is used as a storage region for storing the network equipment list information 48 illustrated in FIG. 1. The network equipment detail storage region 86 is used as a storage region for storing the network equipment detailed information 50 illustrated in FIG. 1. The physical server list storage region 87 is used as a storage region for storing the physical server list information 52 illustrated in FIG. 1.

The CPU 56 reads the power control planning program 68 from the storage unit 66 and loads the power control planning program 68 in the memory 58, and sequentially executes processes described in the power control planning program 68. As a result, the computer 54 operates as the power control planning unit 20 illustrated in FIG. 1. By reading the power control planning program 68 from the storage unit 66, loading the power control planning program 68 in the memory 58, and executing the power control planning program 68, the computer 54 also operates as the planning unit 22 of the power control planning unit 20 illustrated in FIG. 1.

The power control planning program 68 includes descriptions of a power check process 69 and a rearrangement/initiation process 70. The CPU 56 operates as the power check unit 24 illustrated in FIG. 1 by executing the power check process 69. The CPU 56 also operates as the rearrangement/initiation unit 26 illustrated in FIG. 1 by executing the rearrangement/initiation process 70.

The CPU 56 reads the power control program 76 from the storage unit 66 and loads the power control program 76 in the memory 58, and sequentially executes processes described in the power control program 76. As a result, the computer 54 operates as the power controller 34 illustrated in FIG. 1. The power control program 76 includes descriptions on the network power management process 77 and the server power management process 78. The CPU 56 operates as the network power management unit 36 illustrated in FIG. 1 by executing the network power management process 77. The CPU 56 also operates as the server power management unit 38 illustrated in FIG. 1 by executing the server power management process 78. Thus, the computer 54 functions as the power control device 12 by executing the power control planning program 68, the status acquisition program 72, the power control program 76, and the configuration management program 80.

Next, operations of the power control system 10 according to the present embodiment will be described.

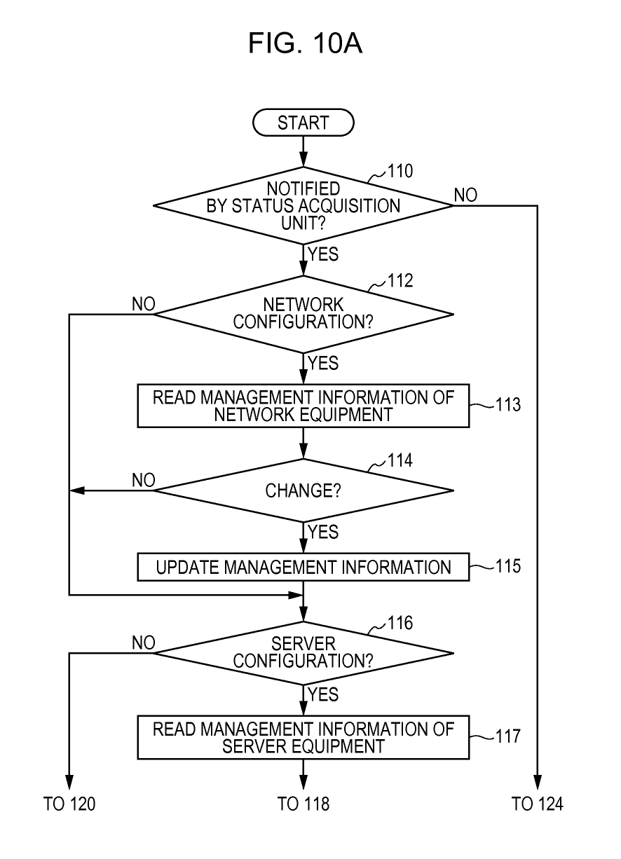

FIG. 9 illustrates an example of a flow of a process of the status acquisition unit 28 that operates on the computer 54 when the power control device 12 of the power control system 10 is implemented by the computer 54. The status acquisition unit 28 executes the status acquisition process illustrated in FIG. 9 at regular time intervals. The status acquisition unit 28 acquires the status, connection path, and connection status of the network equipment 14, and notifies the configuration management unit 40 when a change has occurred. The status acquisition unit 28 also acquires the status of the server equipment 16 in cooperation with the virtualization management device 18, and notifies the configuration management unit 40 when a change has occurred.

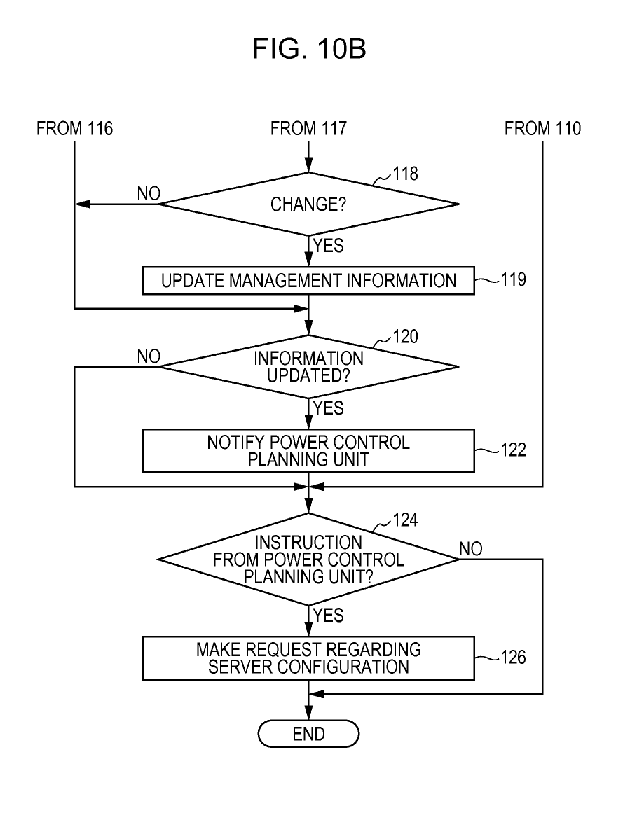

FIG. 10A and FIG. 10B illustrate an example of a flow of a process of the configuration management unit 40 that operates on the computer 54. The configuration management unit 40 executes the configuration management process illustrated in FIG. 10A and FIG. 10B at regular time intervals. The configuration management unit 40 updates management information related to the network equipment 14 and the server equipment 16 when a change has occurred in the status of the network equipment 14 and the server equipment 16, respectively. That is, the configuration management unit 40 updates either one of the network equipment list information 48, the network equipment detailed information 50, and the physical server list information 52. The configuration management unit 40 notifies the power control planning unit 20 when a change has occurred in the status of at least one of the network equipment 14 and the server equipment 16.

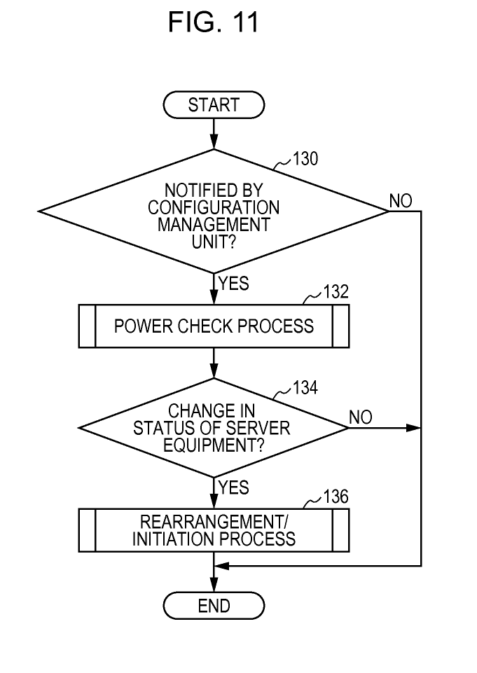

FIG. 11 illustrates an example of a flow of a process of the power control planning unit 20 that operates on the computer 54. The power control planning unit 20 executes a power control planning process illustrated in FIG. 11 at regular time intervals. The power control planning unit 20 plans power control for the network equipment 14 and migration (rearrangement) of a virtual machine, and issues an instruction to the power controller 34.

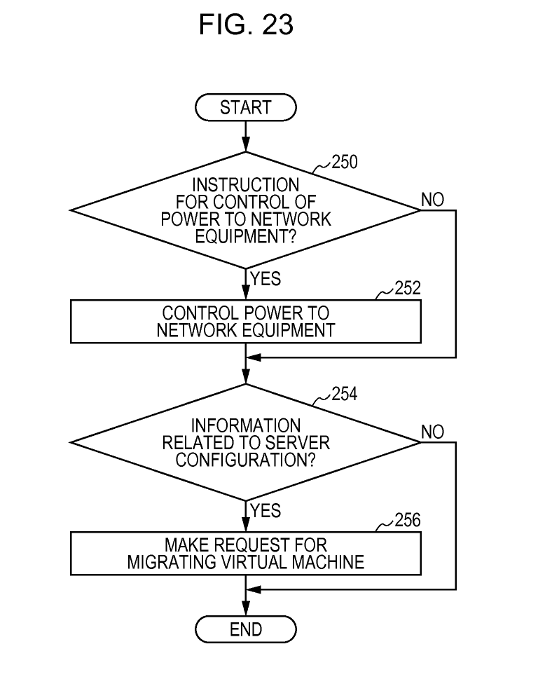

FIG. 23 illustrates an example of a flow of a process of the power controller 34 that operates on the computer 54. The power controller 34 executes a power management process illustrated in FIG. 23 at regular time intervals. The power controller 34 performs power control of powering on or off for the network equipment 14. The power controller 34 also executes a process of requesting the virtualization management device 18 to migrate a virtual machine.

Each process in the power control device 12 will be described in detail below.

In 100 of the status acquisition process illustrated in FIG. 9, the status acquisition unit 28 acquires the status, connection path, and connection status of the network equipment 14. The connection status between pieces of network equipment 14 may be acquired, for each piece of network equipment 14, by detecting information regarding a piece of network equipment 14 to which each piece of network equipment 14 is connected. The status of the network equipment 14 may be acquired by detecting information indicating an operating status of each piece of network equipment 14. Next, in 102, in cooperation with the virtualization management device 18, the status acquisition unit 28 acquires the status of the server equipment 16. For example, the status acquisition unit 28 requests the virtualization management device 18 to issue notification of the status of the server equipment 16, and acquires information indicating the status of the server equipment 16, which is notified by the virtualization management device 18.

Next, in 104, the status acquisition unit 28 determines whether or not a change has occurred with regard to at least either one of the information acquired in 100 and the information acquired in 102. The determination processing in 104 may be made by comparing the information acquired in 100 and 102 with the network equipment list information 48, the network equipment detailed information 50, and the physical server list information 52 stored in the storage unit 46. The status acquisition unit 28 may acquire the network equipment list information 48, the network equipment detailed information 50, and the physical server list information 52 for comparison by requesting the configuration management unit 40. The status acquisition unit 28 may temporarily store the acquired information to use the temporarily stored information. When a change has occurred with regard to any information, the status acquisition unit 28, in 106, notifies the configuration management unit 40 of the changed information. When no change has occurred with regard to either information, the status acquisition unit 28 makes a negative determination in 104, and completes the status acquisition process.

The processing of 100 illustrated in FIG. 9 corresponds to processing of the path acquisition process 73 which is executed by the computer 54 operating as the path acquisition unit 30 of the status acquisition unit 28. The processing of 102 corresponds to processing of the equipment status acquisition process 74 which is executed by the computer 54 operating as the equipment status acquisition unit 32 of the status acquisition unit 28.

The determination processing for a change with regard to information in 104 of the status acquisition process may be omitted. In the case where the determination processing for a change with regard to information is omitted, the configuration management unit 40 is notified of the acquired information and makes a determination of whether or not a change has occurred with regard to the notified information.

In 110 of the configuration management process illustrated in FIG. 10A, the configuration management unit 40 determines whether or not notification has been received from the status acquisition unit 28. When an affirmative determination is made, the process proceeds to 112. When a negative determination is made, the process proceeds to 124 illustrated in FIG. 10B. In 112, the configuration management unit 40 determines whether or not the notification received from the status acquisition unit 28 includes information related to a network configuration. When an affirmative determination is made, the process proceeds to 113. When a negative determination is made, the process proceeds to 116. In 113, the configuration management unit 40 reads management information including the network equipment list information 48 and the network equipment detailed information 50 stored in the storage unit 46. In 114, the configuration management unit 40 determines whether or not there is a difference between the information received from the status acquisition unit 28 and the management information read from the storage unit 46. When an affirmative determination is made, the process proceeds to 115. When a negative determination is made, the process proceeds to 116. In 115, the configuration management unit 40 updates the network equipment list information 48 and the network equipment detailed information 50 using the information received from the status acquisition unit 28.

Next, in 116, the configuration management unit 40 determines whether or not the notification received from the status acquisition unit 28 includes information related to a server configuration. When an affirmative determination is made, the process proceeds to 117. When a negative determination is made, the process proceeds to 120 illustrated in FIG. 10B. In 117, the configuration management unit 40 reads management information including the physical server list information 52 stored in the storage unit 46. Next, in 118 illustrated in FIG. 10B, the configuration management unit 40 determines whether or not there is a difference between the information received from the status acquisition unit 28 and the management information read from the storage unit 46. When an affirmative determination is made, the process proceeds to 119. When a negative determination is made, the process proceeds to 120. In 119, the configuration management unit 40 updates the physical server list information 52 using the information received from the status acquisition unit 28.

In 120, the configuration management unit 40 determines whether or not management information has been updated. When management information has been updated, the configuration management unit 40 makes an affirmative determination in 120, and next, in 122, notifies the power control planning unit 20 that the management information has been updated. When management information has not been updated, the configuration management unit 40 makes a negative determination in 120, and the process proceeds to 124.

In 124, the configuration management unit 40 determines whether or not an instruction has been received from the power control planning unit 20. When a negative determination is made, the configuration management process is completed. When an instruction has been received from the power control planning unit 20, the configuration management unit 40 makes an affirmative determination in 124. Next, in 126, based on the instruction received from the power control planning unit 20, the configuration management unit 40 makes a request regarding the server configuration to the virtualization management device 18.

The processing of 112 to 115, 120, and 122 illustrated in FIG. 10A or FIG. 10B corresponds to processing of the network configuration management process 81 which is executed by the computer 54 operating as the network configuration management unit 42 of the configuration management unit 40. The processing of 116 to 119 and 120 to 126 corresponds to processing of the server configuration management process 82 which is executed by the computer 54 operating as the server configuration management unit 44.

In the power control planning process illustrated in FIG. 11, the power control planning unit 20 plans to perform power control for the network equipment 14 and to migrate (rearrange) a virtual machine, and issues instructions to the configuration management unit 40 and the power controller 34. First, in 130 of the power control planning process illustrated in FIG. 11, the power control planning unit 20 determines whether or not notification has been received from the configuration management unit 40. When a negative determination is made, the power control planning process is completed. When an affirmative determination is made, the process proceeds to 132. In 132, the power control planning unit 20 executes a power check process in which power control for the network equipment 14 is performed (described in detail later). In 134, the power control planning unit 20 acquires information indicating the status of server equipment managed by the virtualization management device 18, and determines whether or not a change has occurred in the status of the server equipment 16. When a negative determination is made in 134, the power control planning unit 20 completes the power control planning process. When an affirmative determination is made, the process proceeds to 136. In 136, the power control planning unit 20 executes a rearrangement/initiation process including planning of migration (rearrangement) of a virtual machine (described in detail later). The power control planning unit 20 issues an instruction for power control for the network equipment 14 and an instruction for implementation of planning of migration (rearrangement) of a virtual machine to the power controller 34 or the like.

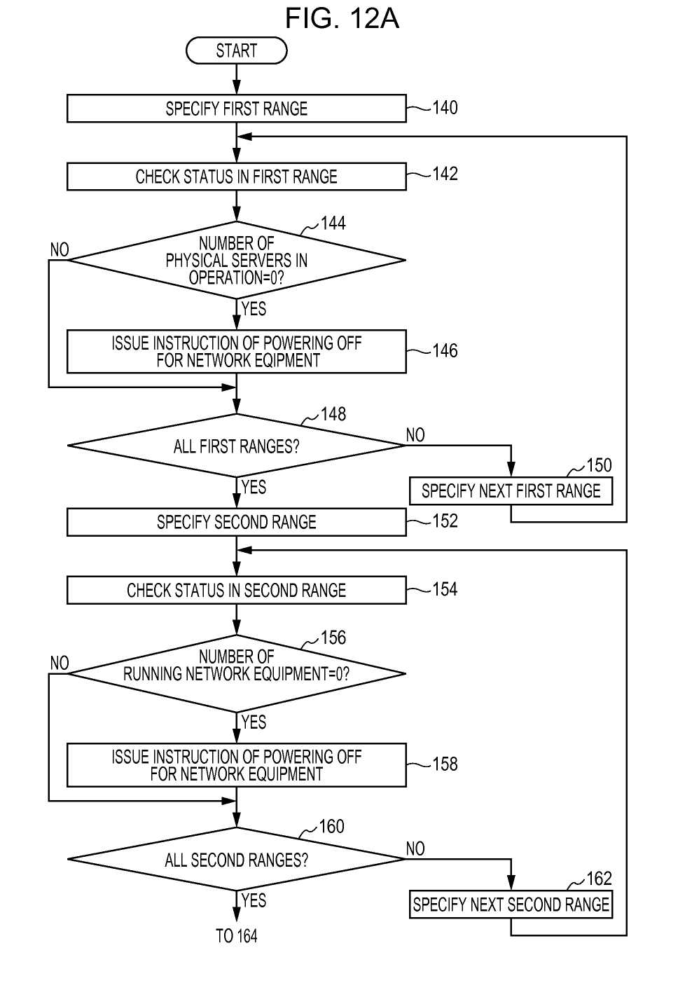

FIG. 12A and FIG. 12B illustrate an example of a flow of a power check process executed by the power control planning unit 20. In 132 illustrated in FIG. 11, the power control planning unit 20 executes the power check process illustrated in FIG. 12A and FIG. 12B.

In 140 of the power control process illustrated in FIG. 12A, the power check unit 24 of the power control planning unit 20 specifies one first range in the network environment 15, and next, in 142, detects (status check) a status of the equipment in the specified first range. That is, the power check unit 24 specifies a first range on the basis of management information including the network equipment list information 48, the network equipment detailed information 50, and the physical server list information 52, and detects the statuses of the equipment in the specified first range. Next, in 144, the power check unit 24 determines whether or not the number of physical servers SV in operation in the first range is “0”. The operation of each physical server SV in the first range may be determined based on the physical server list information 52 (FIG. 6). That is, in the physical server list information 52, when PSRV-STATUS is “running”, a corresponding physical server SV is running. When PSRV-STATUS is “off” indicating a state of powered off, the physical server SV is not in operation. When PSRV-STATUS is “on” indicating a state of powered on, the physical server SV is in a state of powered on but is not running, that is, the physical server SV is not in operation.

When a negative determination is made in 144, the process proceeds to 148. When an affirmative determination is made, the power check unit 24 performs processing of 146 and then the process proceeds to 148. In 146, the power check unit 24 instructs the power controller 34 to power off the network equipment 14 included in the first range. That is, based on the physical server list information 52, the power check unit 24 identifies a piece of network equipment 14 connected to the physical servers SV not in operation, which is indicated by PARENT-NODE-ID, and instructs the power controller 34 to power off the identified piece of network equipment 14. In 148, the power check unit 24 determines whether or not the status check has been completed for all the first ranges in the network environment 15. When a negative determination is made, the power check unit 24 specifies the next first range in 150, and then returns the process to 142. When an affirmative determination is made in 148, the process proceeds to 152.

In the network environment 15, there are some cases where one physical server SV is connected to plural pieces of network equipment 14. For example, there is a case where the network equipment 14 is made redundant, or there is a case where the network equipment 14 is connected to a plurality of networks.

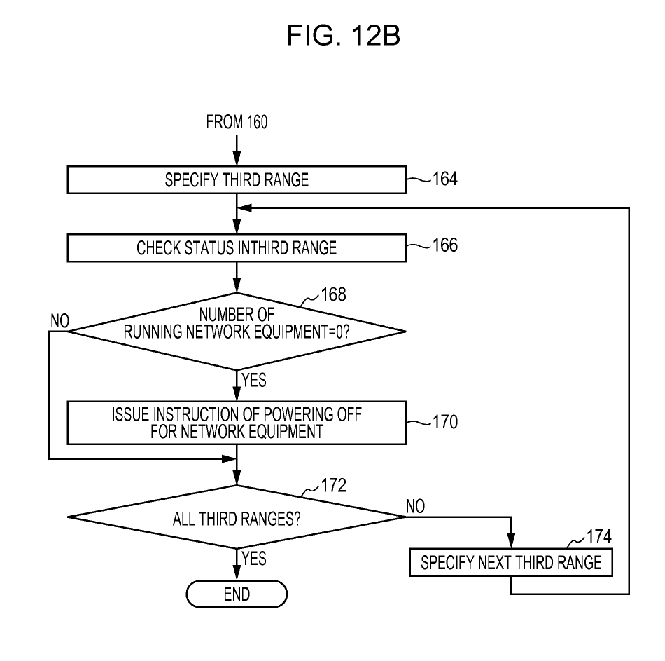

FIG. 13 illustrates an example of the relationship of equipment connection in which physical servers SV are each connected to plural pieces of network equipment 14, as a first range. FIG. 13 illustrates an example where four physical servers SV-R1-01 to SV-R1-04 are each made redundant, and thus are connected to respective ports of each of the switches SW-R1-1 and SW-R1-2.

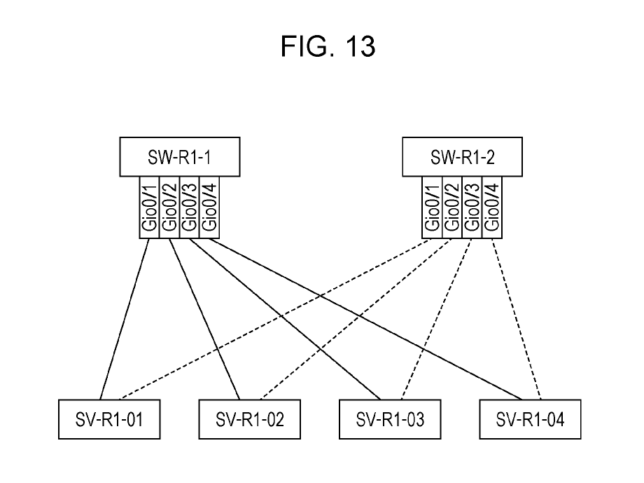

FIG. 14 depicts an example of the physical server list information 52 for the configuration illustrated in FIG. 13. FIG. 14 represents a situation after PSRV-STATUS of the physical server SV-R1-01 changes from “running” where the physical server SV-R1-01 is running, to “off” where the physical server SV-R1-01 is in a state of powered off, under the condition that PSRV-STATUS of each of the physical servers SV-R1-02 to SV-R1-04 is “off”.

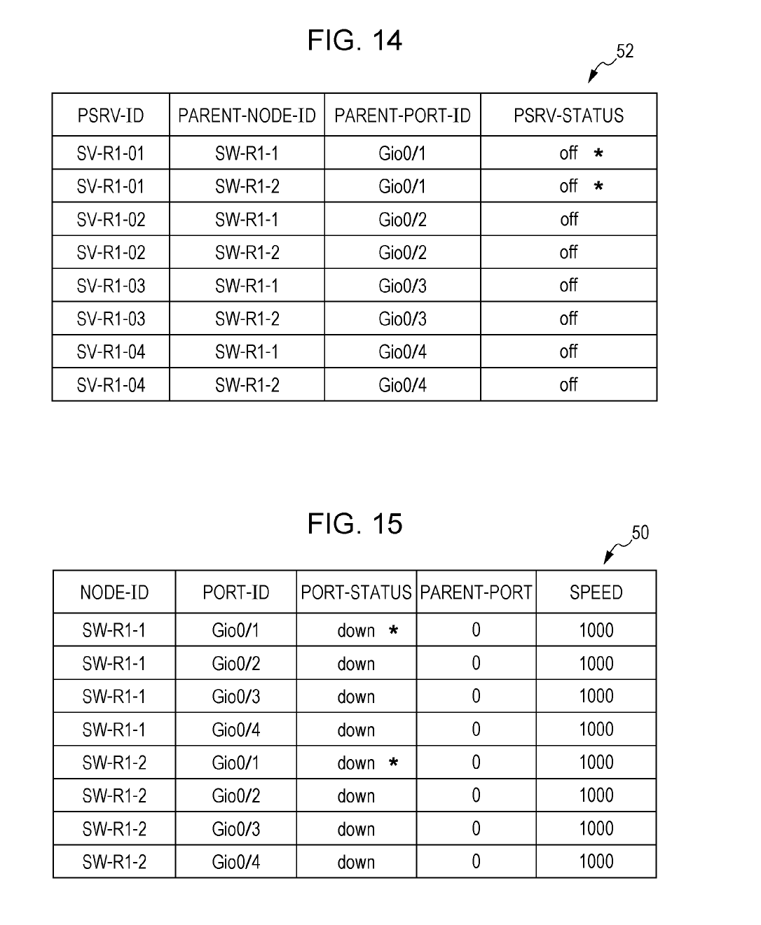

FIG. 15 depicts an example of the network equipment detailed information 50 for the configuration illustrated in FIG. 13. FIG. 15 represents a situation after PORT-STATUS of a port with PORT-ID of “Gio0/1” of each of the switch SW-R1-1 and the switch SW-R1-2 has changed from “up” where the port is operating to “down” where the port is stopped.

In the case of the configuration illustrated in FIG. 13, the power check unit 24 of the power control planning unit 20 determines, as the power check process, whether or not equipment in a first range is in a state of powered off using the physical server list information 52 depicted in FIG. 14 and the network equipment detailed information 50 depicted in FIG. 15. That is, a physical server SV whose status has changed is identified using the physical server list information 52, and pieces of network equipment 14 connected to the identified physical server SV are detected. When the operating statuses of the physical servers SV in the first range indicate that the physical servers SV are not in operation, the operating statuses of pieces of network equipment 14 are detected using the network equipment detailed information 50, and it is determined whether or not the pieces of network equipment 14 of the first range are to be powered off.

Next, in 152 of the power control process illustrated in FIG. 12A, the power check unit 24 specifies one second range in the network environment 15, and subsequently, in 154, detects (status check) a status of the equipment in the specified second range. That is, the power check unit 24 specifies a second range on the basis of the network equipment list information 48 and the network equipment detailed information 50, and detects statuses of pieces of network equipment 14 in the second range. Next, the power check unit 24 determines, in 156, whether or not the number of running network equipment 14 in the second range is “0”. The running network equipment 14 may be identified based on the network equipment detailed information 50 (FIG. 5). That is, when PORT-STATUS of a piece of network equipment 14 is “up” in the network equipment detailed information 50, the piece of network equipment 14 is in operation. When PORT-STATUS is “down” or “nc”, the piece of network equipment 14 is not in operation.

When a negative determination is made in 156, the process proceeds to 160. When an affirmative determination is made, the power check unit 24 performs the processing of 158 and then the process proceeds to 160. In 158, the power check unit 24 instructs the power controller 34 to power off the network equipment 14 included in the second range. In 160, the power check unit 24 determines whether or not the status check has been completed for all the second ranges in the network environment 15. When a negative determination is made, the power check unit 24 specifies the next second range in 162 and then returns the process to 154. When an affirmative determination is made in 160, the process proceeds to 164 illustrated in FIG. 12B.

In 164, the power check unit 24 specifies a third range, and subsequently, in 166, detects (status check) a status of the equipment in the specified third range. That is, the power check unit 24 specifies a third range on the basis of the network equipment list information 48 and the network equipment detailed information 50, and detects the statuses of pieces of network equipment 14 in the third range. In 168, the power check unit 24 determines whether or not the number of running network equipment 14 in the third range is “0”. The running network equipment 14 may be identified based on the network equipment detailed information 50.

When a negative determination is made in 168, the process proceeds to 172. When an affirmative determination is made, the power check unit 24 performs the processing of 170 and then the process proceeds to 172. In 170, the power check unit 24 instructs the power controller 34 to power off the network equipment 14 included in the third range. In 172, the power check unit 24 determines whether or not the status check has been completed for all the third ranges in the network environment 15. When a negative determination is made, the power check unit 24 specifies the next third range in 174 and then returns the process to 166. When an affirmative determination is made in 172, the power check unit 24 completes the power check process.

The power check process illustrated in FIG. 12A and FIG. 12B represents an example of a process of planning to power off the network equipment 14 in the network environment 15. In contrast, in the network environment 15, there are some cases where a physical server SV is shifted from a state of powered off to a state of powered on and reaches its operating status. In this case, like the flow of the power check process illustrated in FIG. 12A and FIG. 12B, a plan for powering on the network equipment 14 in the order of the first range, the second range, and the third range may be implemented. For example, when the status of a physical server SV transitions to a state of powered on, a plan for powering on a piece of network equipment 14 indicated by the physical server list information 52 and further powering on a piece of network equipment 14 at a higher level is implemented. That is, using the physical server list information 52, the network equipment list information 48, and the network equipment detailed information 50, pieces of network equipment 14 arranged along the connection path from the physical server SV to the network 17 are identified, and a plan for powering on the identified pieces of network equipment 14 is implemented.

One example where a physical server SV is shifted to a state of powered on is the case where, as the load imposed on the network environment 15 increases, the number of physical servers SV caused to run by the virtualization management device 18 increases. According to the present embodiment, a physical server SV whose status has transitioned to a state of powered on is detected based on the physical server list information 52, and pieces of network equipment 14 arranged along the network path of the physical server SV that has transitioned to a state of powered on may be powered on.

When a network path is made redundant, it is preferable that pieces of network equipment 14 arranged along the redundant network paths are also to be powered on. For example, in the network environment 15, one piece of network equipment 14 is connected to plural pieces of network equipment 14 at higher levels in some cases.

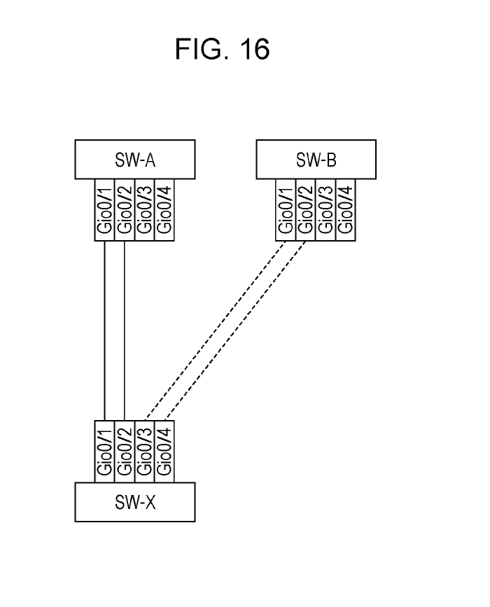

FIG. 16 illustrates an example of the relationship in which one switch SW is connected to two switches SW, which are pieces of network equipment at a higher level. In the example illustrated in FIG. 16, ports of a switch SW-X are redundantly connected to ports of a switch SW-A and ports of a switch SW-B. That is, the switch SW-X is connected to two higher-level nodes (the switches SW-A and SW-B serving as the network equipment 14).

When a physical server SV is shifted to a state of powered on and the network equipment 14 arranged along the network path is to be powered on, each piece of network equipment 14 along all the paths from the physical server SV to the network 17 is powered on when it is in a state of powered off. That is, since redundant paths including pieces of network equipment 14 illustrated in FIG. 16 are provided, at the time of powering on the switch SW-X, higher-level pieces of network equipment 14 (switch SW-A and SW-B) connected to the switch SW-X are also to be powered on. For this reason, based on PARENT-PORT of the network equipment detailed information 50 and the network equipment list information 48, all the higher-level pieces of network equipment 14 to which the piece of network equipment 14 to be powered on is connected are identified and are powered on.

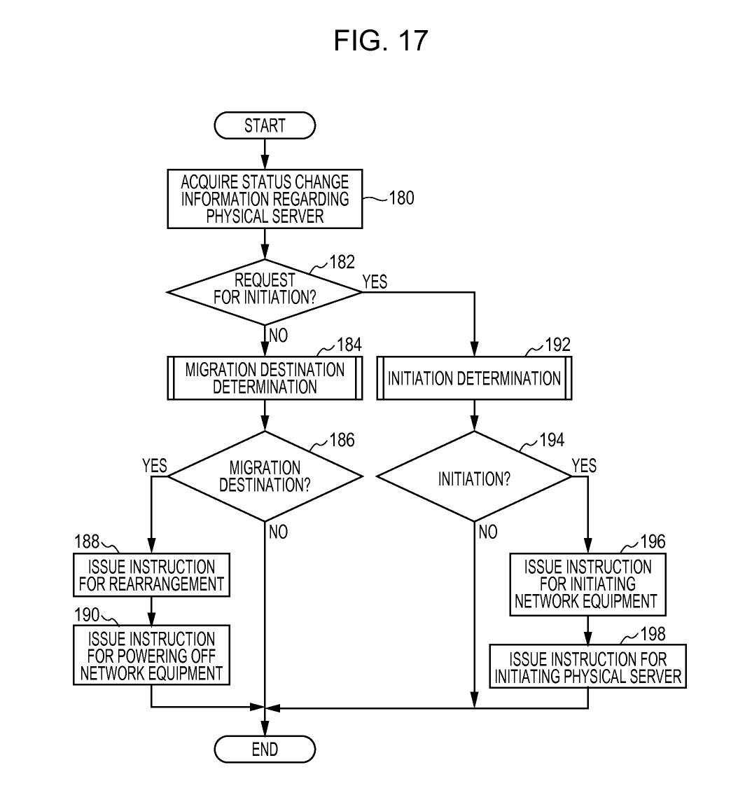

Next, the rearrangement/initiation process executed by the power control planning unit 20 will be described. FIG. 17 illustrates an example of a flow of the rearrangement/initiation process executed by the power control planning unit 20. In 136 illustrated in FIG. 11, the power control planning unit 20 executes the rearrangement/initiation process illustrated in FIG. 17. The rearrangement/initiation process is executed in such a manner that, in accordance with a change in a status of a physical server SV managed by the virtualization management device 18, the rearrangement/initiation process is divided into a process of powering off the network equipment 14 and a process of initiating the network equipment 14.

The process of 132 illustrated in FIG. 11 and the power check process illustrated in FIG. 12A and FIG. 12B correspond to the processing of the power check process 69 which is executed by the computer 54 operating as the power check unit 24 of the power control planning unit 20. The process of 136 illustrated in FIG. 11 and the rearrangement/initiation process illustrated in FIG. 17 correspond to the processing of the rearrangement/initiation process 70 which is executed by the computer 54 operating as the rearrangement/initiation unit 26 of the power control planning unit 20.

In 180 of the rearrangement/initiation process illustrated in FIG. 17, The rearrangement/initiation unit 26 of the power control planning unit 20 acquires information (status change information) indicating a change in a status of a physical server SV managed by the virtualization management device 18. In 180, the rearrangement/initiation unit 26 detects a change in the status of the physical server SV by acquiring status change information regarding the physical server SV from notification issued by the configuration management unit 40. That is, update of the physical server list information 52 is detected. When a change from “off” to “on” is acquired as the status of the physical server SV, based on the notification issued by the configuration management unit 40, it may be detected that the physical server SV is requested to initiate. The configuration management unit 40 may receive information indicating a request for initiation of the physical server SV from the virtualization management device 18 and issue notification to the power control planning unit 20. In 182, the rearrangement/initiation unit 26 determines whether or not information indicating a request for initiation of the physical server SV is included in the status change information. When a negative determination is made in 182, the rearrangement/initiation unit 26 performs processing in and after 184 as processing of powering off a piece of network equipment 14. When an affirmative determination is made in 182, the rearrangement/initiation unit 26 performs processing in and after 192 as processing of initiating a piece of network equipment 14.

The processing of powering off a piece of network equipment 14 performed in and after 184 illustrated in FIG. 17 includes processing of planning migration (rearrangement) of a virtual machine. Planning migration of a virtual machine is to plan to power off a piece of network equipment 14 included in a first range K by migrating a virtual machine running on a physical server SV included in the first range K to a physical server SV included in another first range Z.

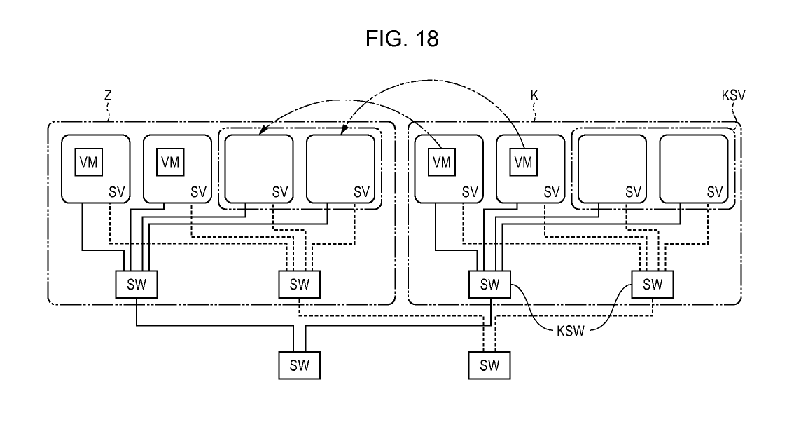

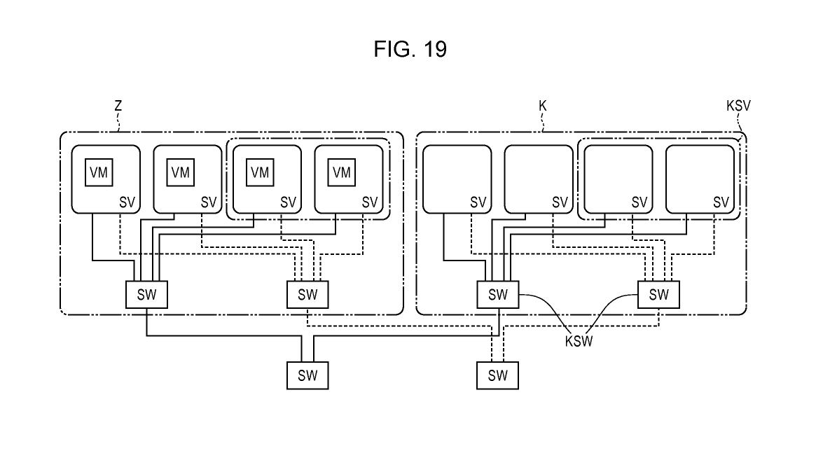

FIG. 18 illustrates an example of the statuses of physical servers SV after acquisition of information indicating changes in the statuses of physical servers SV made by the virtualization management device 18 and before migration (rearrangement) of virtual machines. FIG. 18 illustrates a situation in which a server group KSV including a plurality of physical servers SV is stopped and thus changes have occurred in physical servers SV included in the first range K. In the example of FIG. 18, a virtual machine is denoted by “VM”. FIG. 19 illustrates an example of statuses of physical servers SV after migration of virtual machines VM.

As illustrated in FIG. 18, even when the server group KSV is stopped in the first range K, running physical servers SV are present in the first range K. For this reason, switches KSW, which are pieces of network equipment 14 in the first range K, are not to be powered off.

Therefore, the rearrangement/initiation unit 26 compares operating statuses of physical servers SV in a plurality of first ranges and issues an instruction for rearranging the virtual machines running in the first range K into another first range Z to issue an instruction for powering off the pieces of network equipment 14 in the first range K. The virtualization management device 18 migrates virtual machines VM from the first range K to the first range Z. As a result, the first range K is in a condition where physical servers SV are merely in a state of powered on, which allows the physical servers SV to be powered off and causes communication connection to be stopped. Thus, the pieces of network equipment 14 in the first range may be powered off.

In order to make a plan for rearrangement of virtual machines VM mentioned above, in 184 illustrated in FIG. 17, the rearrangement/initiation unit 26 executes a migration destination determination process (described in detail later) for determining the destination of migration of virtual machines running on physical servers SV in response to a change in the status of a physical server SV. In 186, the rearrangement/initiation unit 26 determines, based on a result of processing of the migration destination determination process, whether or not there is a destination of migration of virtual machines. When there is no destination of migration of virtual machines, the rearrangement/initiation unit 26 makes a negative determination in 186, and completes the rearrangement/initiation process. When there is a destination of migration of virtual machines, the rearrangement/initiation unit 26 makes an affirmative determination in 186 and the process proceeds to 188.

In 188, the rearrangement/initiation unit 26 instructs the virtualization management device 18 to perform rearrangement, by designating the destination of migration of virtual machines based on the result of processing of the migration destination determination process. In 190, the rearrangement/initiation unit 26 plans to power off pieces of network equipment 14 following the migration (rearrangement) of virtual machines, and instructs the power controller 34 to power off the pieces of network equipment 14 in accordance with the plan.

When an affirmative determination is made in 182, the rearrangement/initiation unit 26 executes, in 192, an initiation determination process (described in detail later) for determining a piece of network equipment 14 to be powered on in response to the request for initiation. In 194, based on a result of processing of the initiation determination process, the rearrangement/initiation unit 26 determines whether or not a piece of network equipment 14 to be initiated (powered on) is present. When there is no piece of network equipment 14 to be powered on, the rearrangement/initiation unit 26 makes a negative determination in 186, and completes the rearrangement/initiation process. When there is a piece of network equipment 14 to be powered on, the rearrangement/initiation unit 26 makes an affirmative determination in 194, and the process proceeds to 196.

In 196, the rearrangement/initiation unit 26 instructs the power controller 34 to power on the piece of network equipment 14 identified in 192, to initiate the identified piece of network equipment 14. In 198, the rearrangement/initiation unit 26 notifies the virtualization management device 18 via the configuration management unit 40 of information indicating that the piece of network equipment 14 has been initiated in accordance with the request for initiation, to instruct the virtualization management device 18 to initiate a physical server SV. That is, initiation of the piece of network equipment 14 ensures a connection path in the network environment 15, thus allows a physical server SV to run. Consequently, the rearrangement/initiation unit 26 notifies, as the initiation instruction, the virtualization management device 18 that a physical server SV is to become operable.

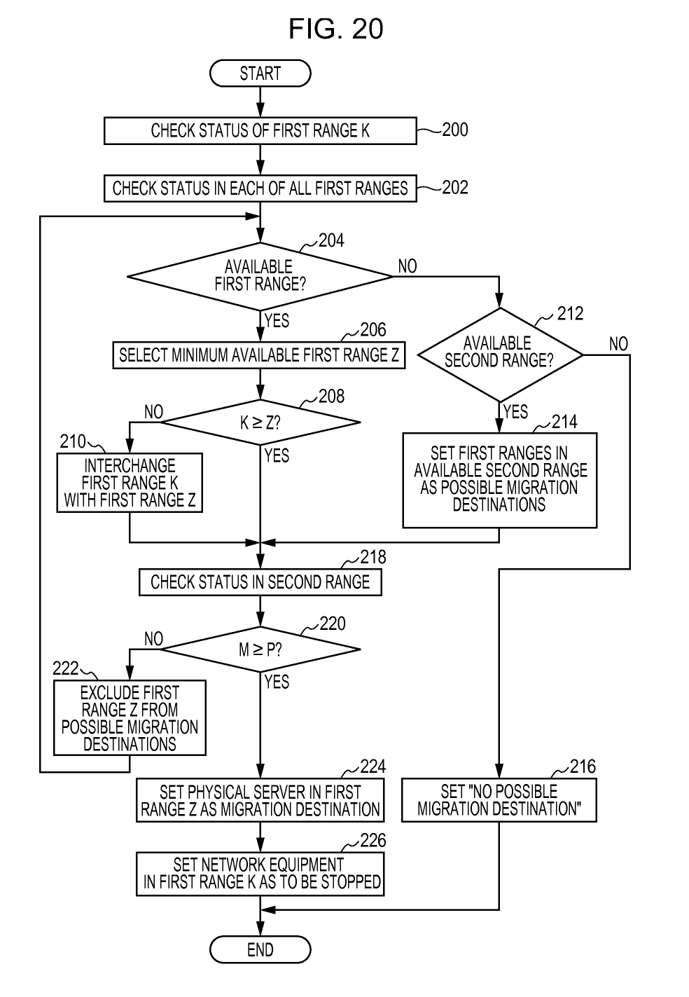

FIG. 20 illustrates an example of a flow of the migration destination determination process executed by the rearrangement/initiation unit 26. In 184 illustrated in FIG. 17, the rearrangement/initiation unit 26 executes the migration destination determination process illustrated in FIG. 20.

In 200 of the migration destination determination process illustrated in FIG. 20, the rearrangement/initiation unit 26 of the power control planning unit 20 checks statuses of pieces of equipment in the first range K in which a piece (physical server SV) of server equipment 16 whose status has been changed is included. In 200, the rearrangement/initiation unit 26 computes, using the management information (the network equipment list information 48, the network equipment detailed information 50, and the physical server list information 52), the total number of connected servers, the number of servers in operation, the number of servers not in operation, and the number of pieces of network equipment. The total number of connected servers is the total number of physical servers SV subordinate to the network equipment 14 in the first range K. The number of servers in operation is the number of physical servers SV in operation in the first range K. The number of servers not in operation is the number of physical servers SV (referred to as available servers) not in operation in the first range K. The number of pieces of network equipment is the total number of pieces of network equipment 14 in the first range K.

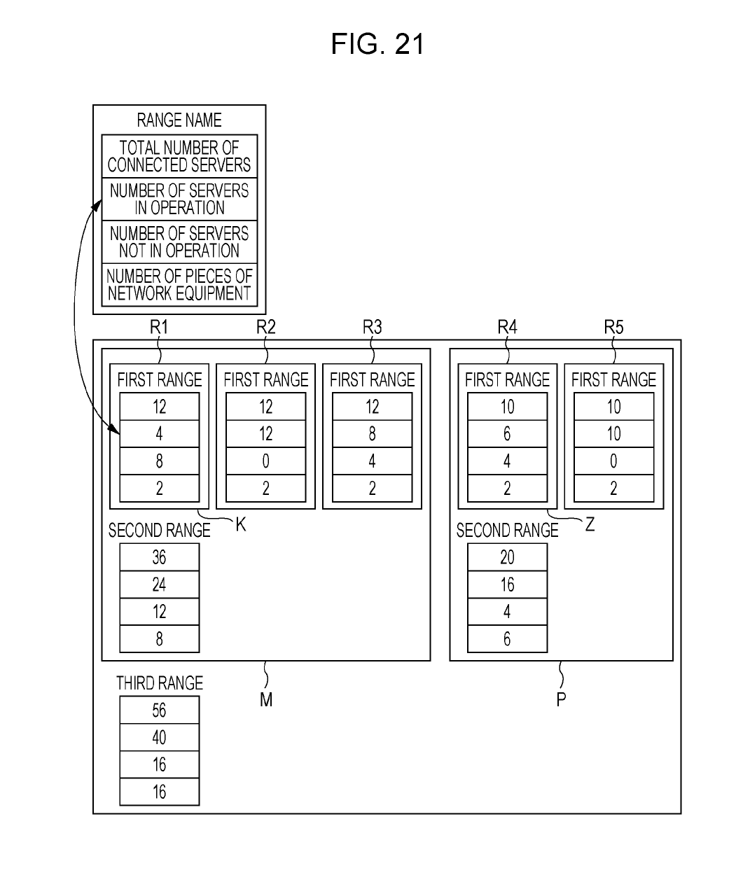

FIG. 21 illustrates an example of the statuses of pieces of equipment in the first range, the second range, and the third range, using five racks R1 to R5 in the network environment 15 (FIG. 2). Note that, for simplicity, FIG. 21 illustrates the case where 12 physical servers SV are included in each of the racks R1 to R3, and 10 physical servers SV are included in each of the racks R4 and R5.

In 202, the rearrangement/initiation unit 26 checks the statuses of pieces of equipment in each of all the first ranges in the network environment 15. In 204, the rearrangement/initiation unit 26 determines whether or not there is a first range (referred to as an available first range) including a sufficient number of available servers, that is, the number of available servers is greater than or equal to the number of physical servers in operation in the first range K to be migrated. When an affirmative determination is made in 204, the process proceeds to 206. When a negative determination is made in 204, the process proceeds to 212.

In 206, the rearrangement/initiation unit 26 selects, from among available first ranges, a first range having a minimum total sum of the total number of connected servers and the number of pieces of network equipment, and sets the selected first range as the first range Z which is a possible migration destination. In 208, the rearrangement/initiation unit 26 determines, with regard to the total sum of the total number of connected servers and the number of pieces of network equipment, whether or not the total sum in the first range K is greater than or equal to the total sum in the first range Z which is a possible migration destination. When a negative determination is made in 208, the rearrangement/initiation unit 26 interchanges the first range K as the source of migration with the first range Z as a possible migration destination in 210, and then the process proceeds to 218. The interchange of the first ranges is an exchange of settings so that the first range K is changed from the migration source to a possible migration destination, and the first range Z is changed from a possible migration destination to the migration source. That is, a first range in which the total sum of the total number of connected servers and the number of pieces of network equipment is smaller and thus power consumption is expected to be smaller is set as the migration destination. When an affirmative determination is made in 208, the process proceeds to 218.

In 218, the rearrangement/initiation unit 26 checks the statuses of pieces of equipment, which includes the number of servers in operation and the number of pieces of network equipment, in each of a second range M including the first range K which is the migration source and a second range P including the first range Z which is a possible migration destination. In 220, the rearrangement/initiation unit 26 determines, with regard to the total sum of the number of servers in operation and the number of pieces of network equipment, whether or not the total sum in the second range M is greater than or equal to the total sum in the second range P which is a possible migration destination. When a negative determination is made in 220, the rearrangement/initiation unit 26 excludes the first range Z from possible migration destinations in 222, and returns the process to 204. The exclusion of a possible migration destination in 222 is performed because even when a virtual machine is migrated from the first range K to the first range Z, the power consumption of the second range P as the possible migration destination is expected to be larger than the power consumption of the second range M serving as the migration source, and thus the effect of reduction in power consumption is expected to be smaller. When an affirmative determination is made in 220, the process proceeds to 224.

In 224, the rearrangement/initiation unit 26 sets a physical server SV in the first range Z, which is a possible migration destination, as a migration destination. In 226, the rearrangement/initiation unit 26 sets the network equipment 14 in the first range K, which is the migration source, as to be stopped. Then, the rearrangement/initiation unit 26 completes the migration destination determination process. Accordingly, the migration destination may be determined so that rearrangement is performed from the first range K, which is the migration source, to a first range having the total sum of the total number of connected servers and the number of pieces of network equipment smaller than the total sum in the first range K. When a plurality of possible migration destinations (first ranges) are present, the migration destination is set among the first ranges in increasing order of the total sum. That is, the first range as the migration destination may be determined so that rearrangement is performed to a first range having the smallest total sum.

When there is no available first range, the rearrangement/initiation unit 26 makes a negative determination in 204. Then, the rearrangement/initiation unit 26 determines, in 212, whether or not there is a second range (referred to as an available second range) including a sufficient number of available servers, that is, the total number of available servers in all the first ranges other than the first range K to be migrated in a second range is greater than or equal to the number of physical servers in operation in the first range K. When an affirmative determination is made in 212, the rearrangement/initiation unit 26 sets, in 214, all the first ranges other than the first range K in available second ranges as possible migration destinations in increasing order of the total sum of the total number of connected servers and the number of pieces of network equipment, and then the process proceeds to 218. When a negative determination is made in 212, the rearrangement/initiation unit 26 sets “no possible migration destination” in 216, and completes the migration destination determination process.

Thus, when a single first range is insufficient for rearrangement, the rearrangement/initiation unit 26 selects an available second range having a minimum total sum of the total number of connected servers and the number of pieces of network equipment. The rearrangement/initiation unit 26 detects, in the selected available second range, a group (referred to as an available first range group) of first ranges including the sufficient number of available servers in total. The first range K is not included in the available first range group. The rearrangement/initiation unit 26 selects, as a possible migration destination, an available first range group having a minimum total sum of the total number of connected servers and the number of pieces of network equipment, from among the detected available first range groups. Accordingly, the rearrangement/initiation unit 26 may set a physical server SV in an available first range group serving as a possible migration destination in which the total amount of power consumption is expected to be smaller.

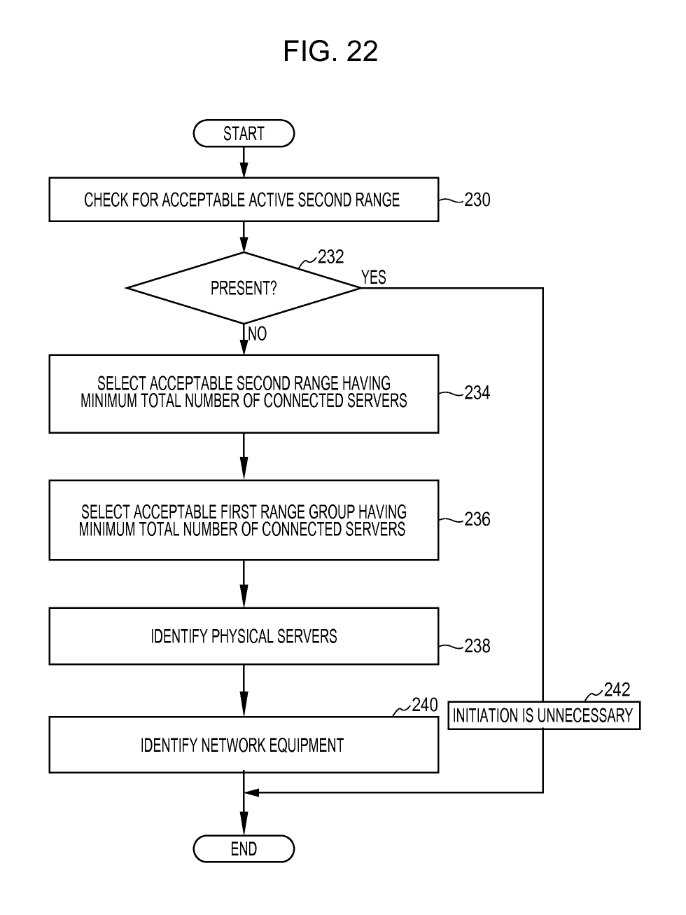

Next, the initiation determination process executed by the rearrangement/initiation unit 26 will be described. FIG. 22 illustrates an example of a flow of the initiation determination process executed by the rearrangement/initiation unit 26. In 192 illustrated in FIG. 17, the rearrangement/initiation unit 26 executes the initiation determination process illustrated in FIG. 22.

In 230 of the initiation determination process illustrated in FIG. 22, the rearrangement/initiation unit 26 of the power control planning unit 20 checks for a second range (referred to as an acceptable active second range) including first ranges (referred to as acceptable active first ranges) which include a sufficient number of available servers in total, that is, the number of available servers in total is greater than or equal to the number of physical servers SV requested to initiate, and each of which includes at least one server in operation. In 230, the rearrangement/initiation unit 26 computes, using management information (the network equipment list information 48, the network equipment detailed information 50, and the physical server list information 52), the total number of connected servers, the number of servers in operation, the number of servers not in operation, and the number of pieces of network equipment. That is, the rearrangement/initiation unit 26 checks the status of equipment in each of all the first ranges in the network environment 15 so as to detect an acceptable active second range.

In 232, the rearrangement/initiation unit 26 determines whether or not an acceptable active second range is present. If an acceptable active second range is present, network equipment 14 connected to the acceptable active first ranges is already in operation. For this reason, when the rearrangement/initiation unit 26 makes an affirmative determination in 232, the rearrangement/initiation unit 26 sets “initiation is unnecessary” in 242, and completes the initiation determination process. When an acceptable active second range is not present, the rearrangement/initiation unit 26 makes a negative determination in 232, and performs processing in and after 234 in order to initiate network equipment 14 not in operation.

In 234, the rearrangement/initiation unit 26 detects a second range (referred to as an acceptable second range) including a sufficient number of connected servers, that is, the total number of connected servers in all the first ranges other than the first range K to be migrated in a second range is greater than or equal to the number of physical servers SV requested to initiate, and selects an acceptable second range having a minimum total number of connected servers from among the detected acceptable second ranges. In 236, the rearrangement/initiation unit 26 detects, in the selected acceptable second range, a group (referred to as an acceptable first range group) of first ranges including the sufficient number of connected servers in total, and selects an acceptable first range group having a minimum total number of connected servers, from among the detected acceptable first range groups. In 238, the rearrangement/initiation unit 26 identifies, in the selected acceptable first range group, physical servers of the number same as the number of physical servers requested to initiate, using the physical server list information 52. In 240, the rearrangement/initiation unit 26 identifies the network equipment 14 in the selected acceptable first range group and the selected acceptable second range using the network equipment list information 48 and the network equipment detailed information 50, and completes the initiation determination process.

In the power control process illustrated in FIG. 23, the power controller 34 controls the power to the network equipment 14 and makes a request for migrating virtual machines. First, in 250 of the power control process illustrated in FIG. 23, the power controller 34 determines whether or not an instruction for control of power provided to the network equipment 14 has been received from the power control planning unit 20. When a negative determination is made, the process proceeds to 254. When an affirmative determination is made in 250, the power controller 34 controls the power to the network equipment 14 in 252 and the process proceeds to 254.

In 254, the power controller 34 determines whether or not notification received from the power control planning unit 20 or the configuration management unit 40 is information related to a server configuration. When a negative determination is made, the power control process is completed. When an affirmative determination is made, the process proceeds to 256. In 256, the power controller 34 requests the virtualization management device 18 to migrate virtual machines.

The processing of 252 illustrated in FIG. 23 corresponds to the processing of the network power management process 77 which is executed by the computer 54 operating as the network power management unit 36 of the power controller 34. The processing of 256 corresponds to the processing of the server power management process 78 which is executed by the computer 54 operating as the server power management unit 38.

As described above, the power control system according to the present embodiment acquires the status of server equipment in a network environment and a network connection path to the server equipment, and performs power control for network equipment on the basis of the status of the server equipment. The power control including that for network equipment performed by the power control system according to the present embodiment may reduce power consumption in a network environment.

According to the present embodiment, pieces of network equipment 14 and pieces of server equipment 16 in the network environment 15 are classified into first to third ranges, and the power control for the network equipment 14 is performed for each of the first to third ranges. Accordingly, power control for the network equipment 14 is performed so as to be adaptive to the status of server equipment in a network environment. Thus, power control that reduces power consumption of the entire network environment 15 may be performed depending on the situation of server equipment.

According to the present embodiment, a physical server SV included in a range where power consumption may be reduced is determined as a migration destination server of a virtual machine running on a physical server SV. Thus, with regard to operation of the server equipment 16, an instruction may be issued for migration of a virtual machine to a physical server SV in a migration destination where power consumption may be reduced.

Next, a second embodiment will be described. In the first embodiment, the status acquisition unit 28 acquires the statuses of the network equipment 14 and the server equipment 16. However, embodiments are not limited to this. For example, the statuses of the network equipment 14 and the server equipment 16 may be monitored by the power control device 12. According to the second embodiment, the statuses of the network equipment 14 and the server equipment 16 are monitored by the power control device 12. Note that the second embodiment has a configuration similar to that of the first embodiment, and thus similar portions are denoted by similar reference numerals and redundant description thereof is omitted.

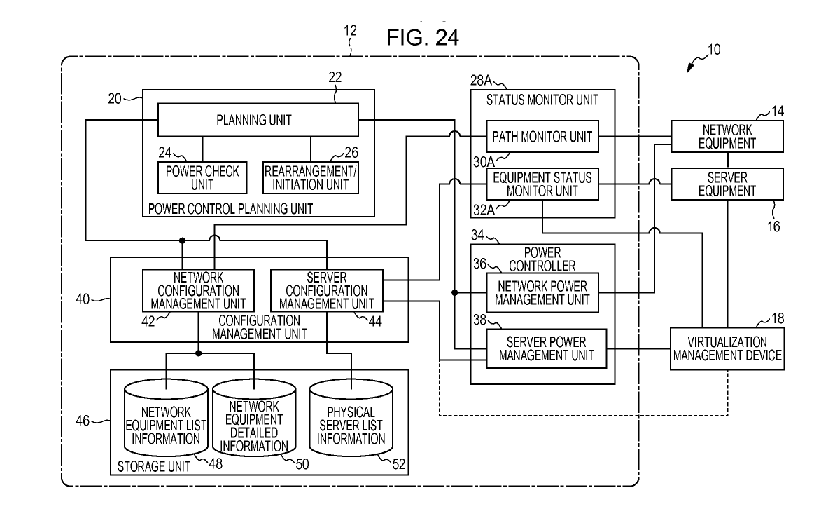

FIG. 24 illustrates an example of a power control system 10 according to the second embodiment. The power control device 12 of the power control system 10 according to the second embodiment includes a status monitor unit 28A.

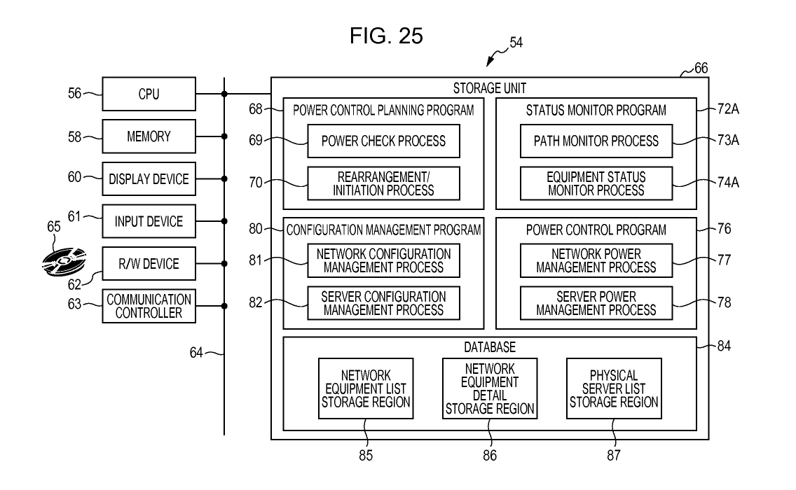

The status monitor unit 28A of the power control device 12 according to the second embodiment includes a path monitor unit 30A and an equipment status monitor unit 32A. The path monitor unit 30A is connected to the network equipment 14 and monitors the status, connection path, and connection status of the network equipment 14 to notify the configuration management unit 40 when a change has occurred. The equipment status monitor unit 32A is connected to the virtualization management device 18 and the server equipment 16, and monitors the status of the server equipment 16 in cooperation with the virtualization management device 18. The equipment status monitor unit 32A also notifies the configuration management unit 40 when the server status has been changed, such as created, updated, deleted, or the like. FIG. 25 illustrates an example of the power control device 12 according to the second embodiment is implemented by a computer 54. A status monitor program 72A in which a path monitor process 73A and an equipment status monitor process 74A are described are stored in the storage unit 66.

The CPU 56 reads the status monitor program 72A from the storage unit 66 and loads the status monitor program 72A in the memory 58, and sequentially executes processes described in the status monitor program 72A. As a result, the computer 54 operates as the status monitor unit 28A illustrated in FIG. 24. The status monitor program 72A includes descriptions of the path monitor process 73A and the equipment status monitor process 74A. The CPU 56 operates as the path monitor unit 30A illustrated in FIG. 24 by executing the path monitor process 73A. The CPU 56 also operates as the equipment status monitor unit 32A illustrated in FIG. 24 by executing the equipment status monitor process 74A.

The power control device 12 according to the second embodiment monitors the status of each of the network equipment 14 and the server equipment 16 at all times, and thus an immediate response to a change in the status of the network equipment 14 or the server equipment 16 may be made.

In the above-described embodiments, the power control device 12 of the power control system 10 is implemented by the computer 54. However, configurations are not limited to this, and, of course, various improvements and changes may be made.

In addition, while the manner in which programs are stored (installed) in advance in a storage unit has been described above, ways to store programs are not limited to his. For example, programs may be provided in the form in which the programs are recorded on a recording medium such as a compact disc read-only memory (CD-ROM), a digital versatile disc (DVD)-ROM, or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A power control device, comprising:
a processor configured to
acquire operating information indicating an operating status of each of first information processing devices connected to first communication equipment as lower level devices than the first communication equipment,
acquire connection information indicating a connection path of the first communication equipment and a connection status of the first communication equipment, and
perform, based on the operating information and the connection information, control of power provided to the first communication equipment depending on the operating status of each of the first information processing devices.

2. The power control device according to claim 1, wherein
the processor is configured to
monitor the operating status of each of the first information processing devices and the connection status of the first communication equipment in order to acquire the operating information and the connection information.

3. The power control device according to claim 1, wherein
the processor is configured to
perform, when it is determined based on the operating information that the first information processing devices are not in operation, control to power off the first communication equipment.

4. The power control device according to claim 3, wherein
second communication equipment is connected to the first communication equipment as higher level equipment than the first communication equipment,
second information processing devices are connected to the second communication equipment as lower level devices than the second communication equipment, the second information processing devices being different from the first information processing devices, and
the processor is configured to
perform, when it is determined that the second information processing devices are not in operation, control to power off the second communication equipment.

5. The power control device according to claim 4, wherein
the processor is configured to
perform, when it is determined that at least one of the second information processing devices is in operation, control not to power off the second communication equipment.

6. The power control device according to claim 1, wherein
the processor is configured to
perform, when it is determined based on the operating information that the first information processing devices are not in operation and at least one of the first information processing devices is changed to be in operation, control to power on the first communication equipment.

7. The power control device according to claim 6, wherein
second communication equipment is connected to the first communication equipment as higher level equipment than the first communication equipment, and
the processor is configured to
perform, when it is determined based on the operating information that the first information processing devices are not in operation and at least one of the first information processing devices is changed to be in operation, control to power on the second communication equipment.

8. The power control device according to claim 1, wherein
the operating information indicates an operating status of a virtual machine running on each of the first information processing devices, and
the processor is configured to
determine, based on the operating information and the connection information, to migrate a first virtual machine running on a source device to a destination device, the source device being one of the first information processing devices, the destination device being different from the first information processing devices, and
transmit information requesting implementation of the migration.

9. A computer-readable recording medium having stored therein a program for causing a computer to execute a process, the process comprising:
acquiring operating information indicating an operating status of each of first information processing devices connected to first communication equipment as lower level devices than the first communication equipment;
acquiring connection information indicating a connection path of the first communication equipment and a connection status of the first communication equipment; and
performing, based on the operating information and the connection information, control of power provided to the first communication equipment depending on the operating status of each of the first information processing devices.

10. The computer-readable recording medium according to claim 9, the process further comprising:
monitoring the operating status of each of the first information processing devices and the connection status of the first communication equipment in order to acquire the operating information and the connection information.

11. The computer-readable recording medium according to claim 9, the process further comprising:
performing, when it is determined based on the operating information that the first information processing devices are not in operation, control to power off the first communication equipment.

12. The computer-readable recording medium according to claim 11, wherein
second communication equipment is connected to the first communication equipment as higher level equipment than the first communication equipment,
second information processing devices are connected to the second communication equipment as lower level devices than the second communication equipment, the second information processing devices being different from the first information processing devices, and
the process further comprises:
performing, when it is determined that the second information processing devices are not in operation, control to power off the second communication equipment.

13. The computer-readable recording medium according to claim 12, the process further comprising:
performing, when it is determined that at least one of the second information processing devices are in operation, control not to power off the second communication equipment.

14. The computer-readable recording medium according to claim 9, the process further comprising:
performing, when it is determined based on the operating information that the first information processing devices are not in operation and at least one of the first information processing devices is changed to be in operation, control to power on the first communication equipment.

15. The computer-readable recording medium according to claim 14, wherein
second communication equipment is connected to the first communication equipment as higher level equipment than the first communication equipment, and
the process further comprises:
performing, when it is determined based on the operating information that the first information processing devices are not in operation and at least one of the first information processing devices is changed to be in operation, control to power on the second communication equipment.

16. The computer-readable recording medium according to claim 9, wherein
the operating information indicates an operating status of a virtual machine running on each of the first information processing devices, and
the process further comprises:
determining, based on the operating information and the connection information, to migrate a first virtual machine running on a source device to a destination device, the source device being one of the first information processing devices, the destination device being different from the first information processing devices; and
transmitting information requesting implementation of the migration.

17. A power control method, comprising:
acquiring, by a computer, operating information indicating an operating status of each of first information processing devices connected to first communication equipment as lower level devices than the first communication equipment;
acquiring connection information indicating a connection path of the first communication equipment and a connection status of the first communication equipment; and
performing, based on the operating information and the connection information, control of power provided to the first communication equipment depending on the operating status of each of the first information processing devices.
